(19) United States
(12) Patent Application Publication
(10) Pub. No.: US 2026/0011935 A1
(43) Pub. Date: Jan. 8, 2026

(54) Wire Clamping Assembly Having Two Housing Parts

(71) Applicant: TE Connectivity India Private Limited, Bangalore (IN)

(72) Inventors: Gururaj SETTRU, Bangalore (IN); Dinesh Kumar SRINIVASAN, Bangalore (IN); Subhasree SAHOO, Bangalore (IN); Ankith RAMESH, Bangalore (IN); Prashanth SURATHKAL, Bangalore (IN); Ravi Molakalmuru RAGHAVENDRA, Bangalore (IN)

(73) Assignee: TE Connectivity India Private Limited, Bangalore (IN)

(21) Appl. No.: 19/257,582

(22) Filed: Jul. 2, 2025

(30) Foreign Application Priority Data
Jul. 3, 2024 (EP) 24186299.4

(51) Int. Cl. H01R 4/48

(52) U.S. Cl. CPC H01R 4/4821; H01R 4/484

(57) ABSTRACT

A wire clamping assembly for automatically clamping an electrical conductor inserted in an insertion direction, comprising a first housing part, a second housing part, and a wire clamping spring. The first housing part is attached to the second housing part and the first housing part and the second housing part define a assembly interior volume extending between them. The wire clamping spring is attached to the first housing part and extends into the assembly interior volume, the wire clamping spring being configured to clamp the electrical conductor.

### CROSS-REFERENCE TO RELATED APPLICATION

This application claims the benefit of European Patent Application No. 24186299.4 filed on Jul. 3, 2024 in the European Patent Office, which is hereby incorporated by reference in its entirety.

### BACKGROUND OF THE INVENTION

The invention relates to a wire clamping assembly for automatically clamping an electrical conductor, such as a lead wire.

Wire clamping assemblies allow to establish a mechanically robust electric connection between an electric conductor, such as a lead wire, and further electric devices. The connection is made by simply pushing the electric conductor into the wire clamping assembly. The electric conductor is then automatically clamped and firmly held by a wire clamping spring of the assembly.

There is a need to provide clamping assemblies that allow to reliably clamp a large range of differently sized electric conductors.

### SUMMARY OF THE INVENTION

This need is addressed by providing a wire clamping assembly for automatically clamping an electrical conductor, such as a lead wire, that is inserted into the wire clamping assembly in an insertion direction, the wire clamping assembly comprising: a first housing part, a second housing part and a wire clamping spring, wherein the first housing part is attached to the second housing part, the first housing part and the second housing part define a assembly interior volume extending between them, and wherein the wire clamping spring is attached to the first housing part and extends into the assembly interior volume, the wire clamping spring being configured to clamp the electrical conductor.

The above wire clamping assembly allows to accommodate a wide variety of different conductor types and sizes. The use of two distinct housing parts allows to adapt the wire clamping assembly modularly to different sizes, depending on how and/or which housing parts are assembled. This flexibility makes the above assembly more versatile than e.g. known assemblies where the housing is a monolithic part.

Further improvements to the above solution may be made by any one of the following features, which are independent from one another with respect to their respective technical effects and can be combined arbitrarily with one another.

In one embodiment, the wire clamping spring may extend into a section of the assembly interior volume towards the second housing part, which section is located in and/or surrounded by the second housing part. Specifically, a free end of the wire clamping spring may be located in this section. In such a configuration, the second housing part may be configured to surround at least partly a wire receptacle, in which the electric conductor is located when clamped. The wire receptacle may be surrounded on at least three sides by the second housing part. The electric conductor may be clamped between the wire clamping spring and the second housing part.

The wire clamping spring may be attached to a rear wall of the first housing part. The rear wall may be located opposite the second housing part and/or face towards the second housing part. The second housing part may comprise a front wall, which is located opposite the rear wall. The wire clamping spring may extend from the rear wall towards the front wall. A free end of the clamping spring, which is configured to clamp the electric conductor may be located opposite the front wall, the wire receptacle being defined between the free end and the front wall.

According to one embodiment, the base area of the wire clamping assembly in a plane perpendicular to the insertion direction may be oblong in a longitudinal direction and the wire clamping spring may extend along the longitudinal direction. In particular, the base are of the wire clamping assembly may be rectangular. The front wall and the rear wall may be located opposite one another in the longitudinal direction.

The wire clamping spring may comprise a fixation section that is fastened to the first housing section. The fixation section may be a straight section of the wire clamping spring that is received e.g. in a shaft or opening of the first housing part. The wire clamping spring may be inserted into the first housing part along the insertion direction or perpendicular to the insertion direction. The wire clamping spring may held at the first housing by at least one of a form fit, a friction fit and a force fit. The wire clamping spring and the first housing may be welded, glued, riveted, crimped and/or hot-stapled. Alternatively, the fixation section may be curved or comprise curved and straight sections.

The wire clamping spring may further comprise a clamping section which may also be straight. The clamping section may extend along the insertion direction, in particular at an oblique angle relative to the insertion direction. The angle between the insertion direction and the clamping spring may be between about 30° and about 60°, in particular about 45°. A free end of the wire clamping spring may be offset in the insertion direction from a position where the wire clamping spring leaves the second housing part. Alternatively, the clamping section may be curved or comprise curved and straight sections.

The wire clamping spring may further comprise an intermediate section, which is located between the fixation section and the clamping section. The intermediate section may be curved in its entirety or comprise folded or curved parts. For example, the intermediate section may be at least partly straight, wherein the straight part of the intermediate section extends is inclined with respect to both the fixation section and the clamping section. In one embodiment, the straight part of the intermediate section is inclined with respect to the clamping section at an angle between about 60° and about 120°, in particular about 90°. With respect to the fixation section, the straight part may be inclined at an angle between about 120° and 135°. The intermediate section may be spaced apart from the first housing part, i.e. be located outside the first housing part.

In one embodiment, one of the first housing part and the second housing part may be inserted into the respective other one of the first housing part and the second housing part. The amount of how much the first housing part and the second housing part are inserted into one another may determine the size of the electric conductor that can be clamped.

The insertion of the first and the second housing part into one another is facilitated if, in one embodiment, at least one of the first and the second housing parts has a substantially U-shaped cross section in a plane perpendicular to the insertion direction.

The legs of the U-shape may be formed from side walls of the respective first and/or second housing part. The side walls may extend parallel to the longitudinal direction and the insertion direction. The front and/or rear wall may connect the two side walls.

The assembly interior volume may extend continuously from the rear wall of the first housing part to the front wall of the second housing part. At least one of the sides that point along the insertion direction may be open at least partly to provide access to the wire receptable.

Each of the first and the second housing part may have an open side which faces the respective other housing part. The wire clamping spring may extend through both open sides.

The first and second housing parts may be configured to be attached to one another in at least two configurations. Each of the at least two configurations may be configured to be used or specified for use with a different range of electric conductor sizes.

The at least two different configurations may be distinguished by any of the following features, or any combination thereof: in the first configuration, the position where the wire clamping spring leaves the first housing part may be further spaced apart from the second housing part than in the second configuration; alternatively or cumulatively, the wire clamping assembly is shorter along a direction perpendicular to the insertion direction, in particular along the longitudinal direction in the first configuration than in the second configuration; alternatively or cumulatively, the front wall and the rear wall are less far spaced apart from one another in the first configuration than in the second configuration; alternatively or cumulatively, one of the first housing part and the second housing part may be inserted further into the respective other one of the second housing part and the first housing part in the first configuration than in the second configuration.

The objective of having at least two configurations may be achieved by providing different fastening locations on the first housing part and the second housing part. In the first configuration, the first and the second housing part may be attached to one another at different fastening locations than in the second configuration. In particular, at least one of the first housing part and the second housing part may comprise at least two fastening locations that are spaced apart from another in a direction perpendicular to the insertion direction such as the longitudinal direction. The fastening locations may be provided on one or both side walls of the respective housing part.

At a fastening location, at least one attachment member may be provided. The attachment members on one of the first and the second housing part may be complementary to the attachment members of the respective other housing part. The attachment members and their complementary attachment members may be configured to provide at least one of a form fit or a frictional fit. For example, a locking recess may be provided as an attachment member at at least one fastening location of one the first and the second housing part and a complementary locking protrusion may be provided as an attachment member at at least one fastening location of the respective other one of the first and the second housing. For attaching the first and the second housing part to one another, the locking recess is brought into engagement with the locking protrusion.

The attachment members may be provided on at least one side wall of the respective first or second housing part. In one embodiment, the attachment members may be provided pairwise, i.e. at one attachment location, there may be provided a pair of attachment members, wherein the pair comprises an attachment member on each of the two side walls.

In one particular embodiment, a snap lock may be formed by the combination of the different attachment locations at the first and second housing part, respectively. The side walls may be resiliently deflectable and serve as springs which generate the necessary spring force for the snap lock.

One of the first and the second housing part may comprise at least one slot through which the respective other one of the first and second housing part extends in at least one of the at least two configurations. A slot may be e.g. formed in a web that is located at an end of a side wall, which end faces the respective other housing part. The slot adds lateral stability especially if the side wall received therein is laterally deflectable, as e.g. in the case of a U-shaped base area. In another one of the at least two configurations, the web may be used as a support for the rear wall, e.g. in that the rear wall is located between the front wall and the web and, with its side facing away from the front wall, rests against the web.

At least one of the first and second housing part may be a molded part made of a plastic material or a stamped and bent metal part made from a metal sheet.

The wire clamping assembly in any of the above embodiments is able to accommodate a large range of differently sized and/or shaped electric conductors, in particular lead wires. In one example, a single assembly can accommodate electrical conductors of various sizes, from 0.2 mm2 to 2.5 mm2 of a stranded wire, and from 0.2 mm2 to 4 mm2 of a solid wire.

According to another aspect, a kit may be provided for assembling a wire clamping assembly as described above. The kit comprises a first housing part and a second housing part, which are configured to be attached to one another in at least two different configurations. Each configuration is configured for clamping a different size of electric conductor. The kit further may comprise at least two different wire clamping springs, which can be interchangeably and selectively mounted to the first housing part. The selective use of one of the at least two wire clamping springs allows adapting the spring parameters to the different configurations, e.g. to select a stiffer spring for large-diameter electric conductors and a softer spring for electric conductors having a small diameter.

The at least two different wire clamping springs may differ in at least one of stiffness, shape, size, e.g. in the length of the clamping section, material thickness and in the shape of their free end with which the electric conductor is clamped.

The first housing parts of the two contact clamping assemblies may be identical. Additionally or alternatively, the second housing parts of the two contact clamping assemblies may be identical.

### BRIEF DESCRIPTION OF THE DRAWINGS

In the following, exemplary embodiments are described with reference to the figures. In the figures, the same reference numerals are used for elements that correspond to one another in terms of their function and/or structure. As described above, an element of an embodiment can be omitted if its technical effects is not needed for a particular application, and vice versa: an element that is not part of a specific embodiment may be added if its technical effect is advantageous in a specific application. In the figures:

FIG. 1 shows a schematic perspective view of a wire clamping assembly;

FIG. 2 shows a schematic perspective view of a detail of the wire clamping assembly of FIG. 1;

FIG. 3 shows a schematic perspective view of another detail of the wire clamping assembly of FIG. 1;

FIG. 4 shows a schematic perspective view of another wire clamping assembly;

FIG. 5 shows a schematic perspective view of a detail of the wire clamping assembly of FIG. 4;

FIG. 6 shows a schematic perspective view of another detail of the wire clamping assembly of FIG. 3;

FIG. 7 shows a schematic perspective view of a wire clamping spring;

FIG. 8 shows a schematic perspective view of a first housing part of the wire clamping assembly.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

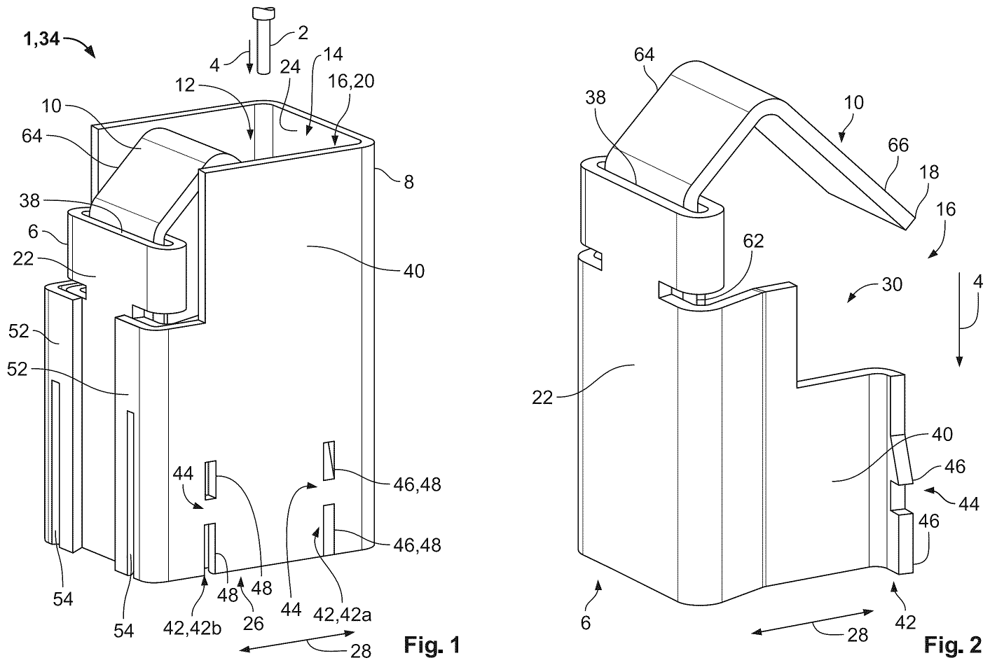

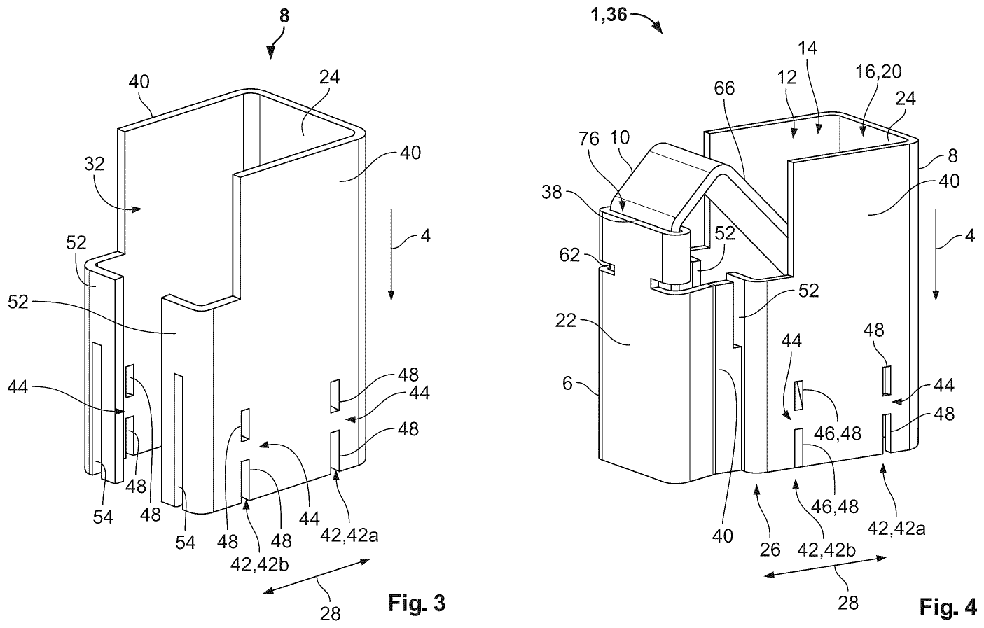

A first embodiment of a wire clamping assembly 1 for automatically clamping an electrical conductor 2, in particular a lead wire, is first described with reference to FIGS. 1 to 3. The electric conductor 2 is inserted into the assembly 1 in an insertion direction 4 and, upon insertion, clamped automatically in a way that it cannot be pulled out of the assembly 1.

The wire clamping assembly 1 comprises a first housing part 6, a second housing part 8 and a wire clamping spring 10. The first housing part 6 is attached to the second housing part 8. The first housing part 6 and the second housing part 8 define an assembly interior volume 12 extending between them. Both housing parts surround the assembly interior volume 12 at least partly in a plane perpendicular to the insertion direction 4. The first housing part 6 may be a moulded plastic material part or a stamped and bent part made from a metal sheet. Independent thereof, the second housing part 8 may be a moulded plastic material part or a stamped and bent part made from a metal sheet.

The wire clamping spring 10 is attached to the first housing part 6 and extends from the first housing part 6 towards the second housing part 8 into the assembly interior volume 12. The entire wire clamping spring 4 may be accommodated in the assembly interior volume 12. Alternatively, part of the wire clamping spring 10 that is located closer to the first housing part 6 than to the second housing part 8 may lie outside the assembly interior volume 12, whereas a part of the wire clamping spring 10 that is located closer to the second housing part 8 than to the first housing part 6 may be received in a section 14 of the assembly interior volume 12, which section 14 is surrounded in the second housing part 8, i.e. surrounded at at least three sides by the second housing 8.

A space 16 between a free end 18 of the wire clamping spring 10 and the second housing part 8 defines a wire receptacle 20. The electric conductor 2 is inserted into the space 16 thereby deflecting part of the wire clamping spring 10 towards the first housing 6, thereby being clamped by the free end 18. The free end 18 of the wire clamping spring 10 points in the insertion direction 4, so that any pulling force acting on the electric conductor 2 against the insertion direction 4 will increase the clamping force.

The wire clamping spring 10 may be attached to the first housing part 6 at a rear wall 22 which is located opposite the second housing part 8. In particular, the rear wall 22 may be opposite a front wall 24 of the second housing part 8.

A base area 26 of the wire clamping assembly 1 may be oblong in a longitudinal direction 28. The front and the rear wall 22, 24 may form two short sides of a rectangular base area 26. In such a configuration, the wire clamping spring 10 may extend from the first housing part 6 towards the second housing part 8 along the longitudinal direction 28.

The first housing part 6 may comprise an open side 30 facing towards the second housing part 8. The open side 30 may be located opposite the rear wall 22. The second housing part 8 may comprise an open side 32 facing towards the first housing part 8. The open side 32 may be located opposite the front wall 24. Moreover any open side 30, 32 may be located between the rear wall 22 and the front wall 24 in the wire clamping assembly 1. The wire clamping spring 10 may extend through at least one of the two open sides 30, 32.

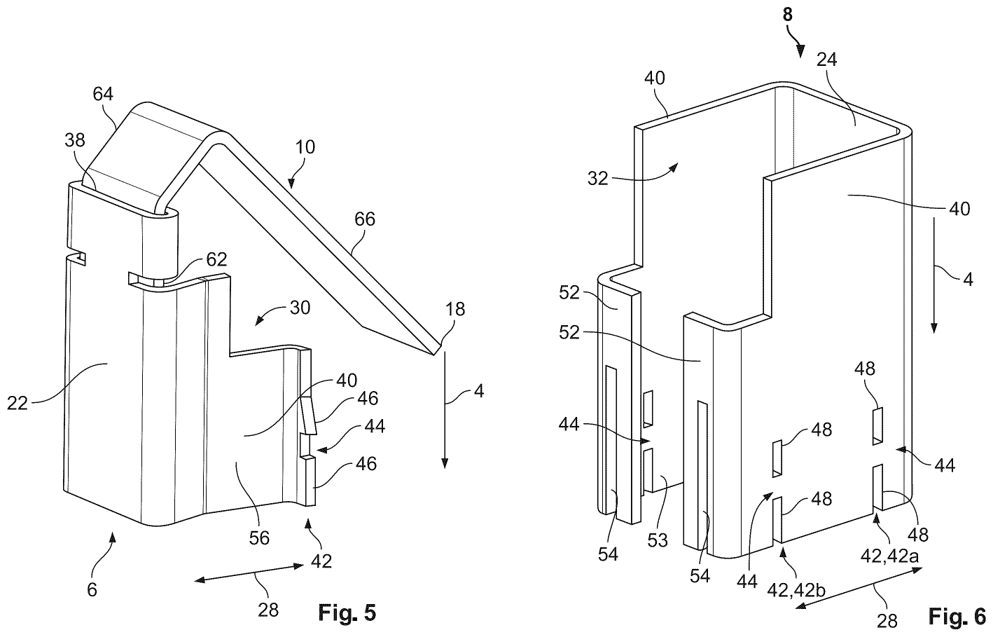

The provision of two separable housing parts 6, 8 allows to assemble the wire clamping assembly in two different configuration 34, 36. The first configuration is shown in FIGS. 1 to 3, the second configuration 36 is shown in FIGS. 4 to 6. The first configuration 34 is used for electric conductors 2 that have a smaller diameter and the second configuration 36 is used for electric conductors 2 that have a larger diameter. In the second configuration 36, a different wire clamping spring 10 may be used than in the first configuration 34. In particular, the wire clamping spring 10 used in the first configuration 34 may be larger and/or stiffer than the wire clamping spring 10 used in the second configuration 36.

When attached to one another in any of the configurations 34, 36, one of the first and the second housing part 6, 8 may be inserted into the respective other housing part 8, 6. For example, one housing part 6, 8 may penetrate the open side 30, 32 of the respective other housing part 6, 8. The two open sides 30, 32 may be connected so that the assembly interior volume 12 extends continuously through the two open sides 30, 32. In the embodiment shown, the first housing part 6 is inserted into the second housing part 8 just by way of example. Of course, the second housing part 8 may be inserted into the first housing part 6 in an alternative embodiment.

Comparing the two configurations 34, 36, any of the following characteristics may apply. In the first configuration 34, one of the first and the second housing part 6, 8 may be inserted further into the respective other housing part 8, 6 than in the second configuration. Alternatively or cumulatively, the distance, in particular along the longitudinal direction 28, between the rear wall 22 and the front wall 24 may be smaller in the first configuration 34 than in the second configuration 36. Alternatively or cumulatively, the interior assembly volume 12 may be smaller in the first configuration 34 than in the second configuration 36. Alternatively or cumulatively, a position 38, where the wire clamping spring 10 exits the first housing may be located closer, in particular along the longitudinal direction 28, to the second housing 8 in the first configuration 34 than in the second configuration 36.

According to the embodiment shown in the Figures, the first housing part 6 and the second housing part 8 each may have substantially U-shaped cross sections in a plane perpendicular to the insertion direction 4, where the legs of the U-shape are formed by a pair of side walls 40 that are located opposite one another with respect to the assembly interior volume 12. The rear wall 22 may connect the two side walls 40 of the first housing part 6. The front wall 24 may connect the side walls 40 of the second housing part 8. The side walls 40 may extend perpendicular to the longitudinal direction 28 and parallel to the insertion direction 28. The side walls 40 of one of the two housing parts 6,8 may extend, in particular through the open side 30, 32 of the respective other housing part 8, 6 into the respective other housing part 8, 6. In the first configuration 34, the side walls 40 of the two housing parts 6, 8 may have a larger overlap than in the second configuration 38.

For providing the first configuration 34, the second configuration 36 and possibly one or more further configurations, one housing part 6, 8 may comprise at least two fastening locations 42 and the other housing part 8, 6 may comprise at least one fastening location where the first and the second housing part 6, 8 may be fastened to each other. If two or more fastening locations 42 are provided on one housing part 6, 8 they are spaced from one another along the direction, in which the wire clamping spring 10 extends from the first to the second housing, e.g. along the longitudinal direction 28.

In the embodiment shown, the first housing part 6 comprises one fastening location 42 and the second housing part comprises two fastening locations 42a, 42b. Of course, the first housing part 6 may alternatively comprise two fastening locations 42a, 42b and the second housing part may comprise one fastening location 42. If more than two configurations 34, 36 are provided, one of the housing parts 6, 8 may comprise more than two fastening locations 42. As shown, in the first configuration 34, the fastening location 42 of first housing part 6 is attached to the second housing part 8 at the fastening location 42a of the second housing part 8, i.e. the fastening location 42, which is located closer to the front wall 24 than the fastening location 42b. In the second configuration 36, the fastening location 42 of the first housing part 6 is fastened to the fastening location 42b of the second housing 8, which is located closer to the open side 32 of the second housing 8.

Each fastening location 42 may comprise one or more attachment members 44. The attachment members 44 at the at least one fastening location 42 of one housing part 6, 8 are configured complementary to the attachment members 44 at the at least one fastening location 42 of the respective other housing part 8, 6. This allows engagement of any fastening locations of one housing part with any fastening location of the other housing part. For example, the at least one attachment member 44 of the at least one fastening location 42 of one housing part 8, 6 may be configured to engage the at least one attachment member 44 of the at least one fastening locations 42 of the respective other housing part 6, 8 in at least one of a form fit, force fit and friction fit. In particular, the attachment members 44 of the attachment members of the housing parts 6, 8 may be latched together by providing a snap fit. For this, the attachment members 44 at the at least one fastening location 42 of one housing part, e.g. the first housing part 6, may comprise protrusions 46 that are configured to snap in complementary recesses 48 that are comprised be the attachment members 44 at the fastening location on the second housing part 8. The side walls 40 on which a fastening location 42 is provided may be elastically deflectable in a direction into and out of the assembly interior volume 12. The side walls 40 may thus act as springs which allow a resilient snap-in of the complementary attachment members 44.

An attachment member 44 of the first housing part 6 may comprise, in the specific embodiment that is shown in the figures, two protrusions 46, and an attachment member 44 of the second housing part 8 may comprise two recesses 48 complementary thereto. Each of the two protrusions 46 is received in ta different one of the two recesses 48. The number of protrusions 46 and recesses 48 in an attachment member 44, however, may be different in other embodiments. The attachment members 44 may also be provided in different forms than describe above.

The second housing part 8 may comprise one or more webs 52, which are located opposite the front wall 24. The at least one web 42 may be located at the end of a respective side wall 24 and protruding in a substantially transverse angle thereto towards the assembly interior volume 12, thus reducing the size of the open side 32. Along the insertion direction 4, the at least one web 52 may be of smaller height than the wire clamping assembly 1. As shown, two webs 52 may be provided that are separated from one another by a gap 53 which is a part of the open side 32.

In the first configuration 34, the rear wall 22 may be located between the webs 52 and the front wall 24 and rest against the webs 52. Thus, the webs 52 may be configured to support a force acting on the first housing part 6 generated by the wire clamping spring 4 that is deflected by an electric conductor 2 which clamped by the wire clamping assembly 1.

A web 52 may comprise a slot 54 which is oblong in the insertion direction 4 and may also open in the insertion direction 4. In such a slot 54, a respective side wall 40 of the first housing part 6 may be received in the second configuration 36. In the second configuration, the second side wall 40 of the first housing 6 may extend through the respective slot 54 into the section 14. Specifically, an indented section 56 of a side wall 40 of the first housing part 6 may be inserted into a slot 54, e.g. against the insertion direction. At the indented section 56 the distance between the two side walls 40 of the first housing part 6 is reduced.

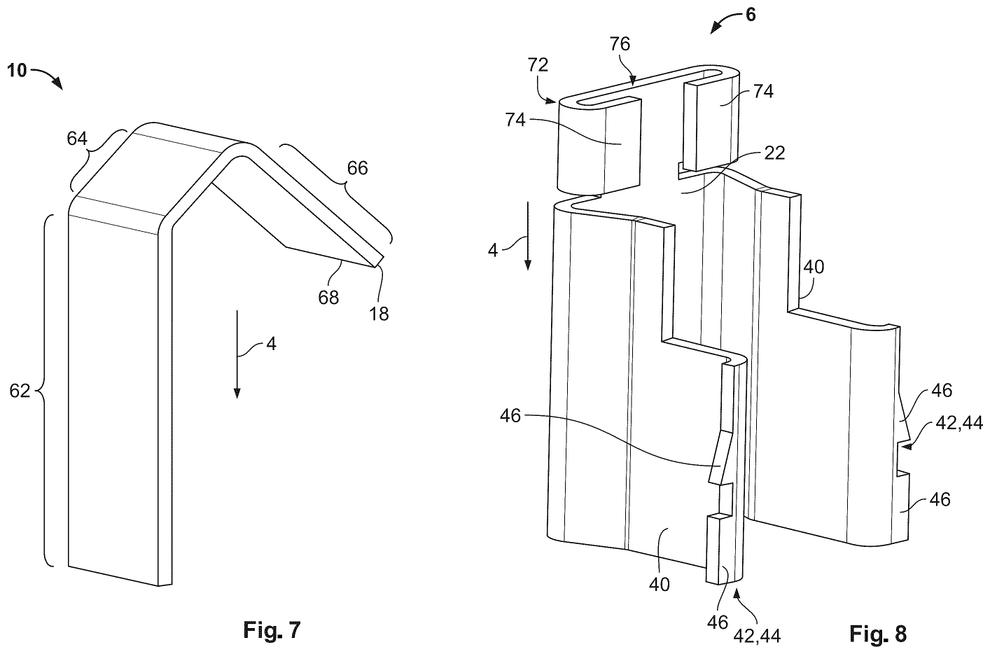

The general structure of a wire clamping spring 10 that can be used in any of the configurations 34, 36 is shown in FIG. 7.

The wire clamping spring 10 may comprise a fixation section 62 which is fixated to the first housing part 6, in particular the rear wall 22. The fixation section 62 may be a straight section of the wire clamping spring 10 and be inserted into a shaft or slot of the first housing part 6, in particular in the insertion direction 4 or perpendicular thereto. In addition or alternatively, the fixation section 62 may be clamped, crimped, welded, riveted and/or glued together with the first housing part 6 in particular at or close to the position 38 where the wire clamping spring 10 exits the first housing part 6. The fixation section 62 of the wire clamping spring 10 may comprise locking features (not shown) such as protrusions, surface roughenings or latching features for improving the engagement with the first housing part 6.

The wire clamping spring 10 may further comprise an intermediate section 64 and a clamping section 66, wherein the free end 18 is located at the end of the clamping section 66 and the intermediate section 64 is located between the fixation section 62 and the clamping section 66.

The clamping section 66 may be straight and extend in the insertion direction 4. In particular, the clamping section 66 may be inclined with respect to the insertion direction 4 at an angle between 30° and 60°, e.g. about 45°. The free end 18 may have one or more sharp edges 68 that are configured to dig into the clamped electric conductor 2.

The intermediate section 64 may in one embodiment be continuously curved from the fixation section 62 to the clamping section 66. As shown, however, the intermediate section 64 comprises a straight part which is joined to the fixation section 62 and the clamping section 66 respectively by two bent or folded segments. The straight part of the intermediate section 62 may extend at an angle of between about 120° and about 135° with respect to the fixation section 62. The angle between the clamping section 66 and the fixation section 62 may be between about 60° and 120°, in particular about 90°.

As already stated above, different types of such a wire clamping spring 10 may be used in the different configurations 34, 36. This allows to provide a clamping force which is commensurate with the different diameters of the electric conductor 2 and reflects the different displacements of the free end 18 by the various conductor diameters. Thus, a clamping spring 10 used in the first configuration 34 may have a smaller material thickness, be smaller and/or have a lower stiffness than a wire clamping spring 10 that is used in the second configuration 36.

As the first and the second housing parts 6, 8 are differently positioned relative to one another in the two configurations 34, 36, the length of the clamping section 66 and/or intermediate section 64, either individually or in combination, of a wire clamping spring 10 that is used in the second configuration 36 may be larger than respective individual or combined length of the clamping section 66 and/or intermediate section 64 of a wire clamping spring that is used in the first configuration 34.

To accommodate wire clamping springs 10 that have different material thicknesses, the first housing part 6, in particular the rear wall 22, may comprise a section 72, shown in FIG. 8, which has two wings 74 that may be crimped around the wire clamping spring 10.

For clamping an electric conductor 2, the conductor 2 is simply inserted along the insertion direction into the assembly interior volume 12. Due to the inclination of the clamping section 66 of the clamping spring 10, the conductor 2 is automatically guided to the wire receptacle 20, i.e. the area that is located between the free end 18 of the clamping spring 10 and the second housing 8. By further pressing the conductor 2 in the insertion direction 4, the clamping section 44 is deflected both in the insertion direction 4 and perpendicular thereto away from the front wall 22 of the second housing part 8. Due to this movement, the conductor 2 can be inserted between the free end 18 and the second housing part 8, in particular the front wall 24. If the conductor 2 is then let loose, it is fixated by the deflected clamping spring 10, in particular its free end 18. To increase the hold, the free end 18 may comprise a sharp edge which digs into the electric conductor 2.

Any attempt to pull out the conductor 2 against the insertion direction 4 will lead to a movement of the free end 18 with the conductor 2. This will lead to a steepening of the clamping section 66, which will be pressed into the intermediate section, thereby increasing the clamping force with which the electric conductor is clamped. Thus, the design and orientation of the clamping spring 10 leads to a clamping that self-enforces if the conductor 2 is pulled against the insertion direction 4.

The provision of two complementary housing parts 6, 8 with different attachment locations 42 and at least one wire clamping spring 10 leads to a modular structure. By attaching the housing parts 6, 8 to one another at different attachment locations 42 and providing different wire clamping springs 10, conductors, in particular lead wires, of a wide variety of diameters may be accommodated and clamped with the appropriate force. Thus, the housing parts 6, 8 and at least one clamping spring 10 forms a kit, from which at least two different wire clamping assemblies 1 may be modularly composed.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A wire clamping assembly for automatically clamping an electrical conductor, such as a lead wire, that is inserted into the wire clamping assembly in an insertion direction, the wire clamping assembly comprising:
a first housing part,
a second housing part and
a wire clamping spring,
wherein the first housing part is attached to the second housing part,
the first housing part and the second housing part define an assembly interior volume extending between them, and
wherein the wire clamping spring is attached to the first housing part and extends into the assembly interior volume, the wire clamping spring being configured to automatically clamp the electrical conductor.

2. The wire clamping assembly according to claim 1,
wherein the wire clamping spring extends into a section of the assembly interior volume, which section is surrounded by the second housing part.

3. The wire clamping assembly according to claim 1,
wherein the wire clamping spring is attached to the first housing part at a housing rear wall, the housing rear wall facing the second housing part with respect to the assembly interior volume.

4. The wire clamping assembly according to claim 1,
wherein the first housing part and the second housing part are configured to be attached to one another in at least two different configurations,
wherein, in one of the at least two different configuration, the position where the wire clamping spring leaves the first housing part is further spaced apart from the second housing part than in another one of the at least two configurations.

5. The wire clamping assembly according to claim 4,
wherein, in one of the at least two configurations, one of the first housing part and the second housing part is inserted further into the respective other one of the first housing part and the second housing part than in another one of the at least two configurations.

6. The wire clamping assembly according to claim 4,
wherein, in one of the at least two configurations, the assembly interior volume is smaller than in another one of the at least two configurations.

7. The wire clamping assembly according to claim 4,
wherein at least one of the first housing part and the second housing part provides at least two different fastening locations, where the respective other one of the first and the second housing part can be attached selectively, the at least two different fastening locations being spaced apart from one another in a direction perpendicular to the insertion direction,
and wherein each of the two different fastening location is assigned to a different configuration.

8. The wire clamping assembly according to claim 7,
wherein, at any of the at least two fastening locations, a snap lock is provided.

9. The wire clamping assembly according to claim 7,
wherein the fastening locations are provided at side walls of the first housing part and the second housing part,
the side walls extending along the wire clamping spring.

10. The wire clamping assembly according to claim 1,
wherein the wire clamping spring comprises a fixation section and a clamping section,
wherein the fixation section is fastened to the first housing part and the clamping section is inclined with respect to the fixation section and extends into the assembly interior volume towards the second housing part.

11. The wire clamping assembly according to claim 10,
wherein the clamping section extends into the insertion direction.

12. The wire clamping assembly according to claim 1,
wherein the wire clamping spring comprises a free end which is located opposite a front wall of the second housing part.

13. The wire clamping assembly according to claim 1,
wherein the wire clamping assembly has an oblong base area having a longitudinal direction and wherein the first housing part and the second housing part are arranged opposite one another with respect to the longitudinal direction.

14. The wire clamping assembly according to claim 1,
wherein at least one of the first housing part and the second housing part is a molded part made from plastic material or a stamped and bent part made from a metal sheet.

15. A kit for assembling a wire clamping assembly according to claim 1,
the kit comprising a first housing, a second housing and at least two different wire clamping springs,
wherein each of the two wire clamping springs is configured to be attached selectively to the first housing and
wherein the first housing and the second housing are configured to be attached to one another in at least two different configurations, wherein each configuration is adapted for clamping a different size of electric conductor.
